(19) United States
(12) Patent Application Publication
(10) Pub. No.: US 2022/0158708 A1
(43) Pub. Date: May 19, 2022

(54) METHODS, TERMINAL DEVICE AND BASE STATION FOR RESOURCE ALLOCATION

(71) Applicant: Telefonaktiebolaget LM Ericsson (publ), Stockholm (SE)

(72) Inventor: Zhang ZHANG, Beijing (CN)

(73) Assignee: Telefonaktiebolaget LM Ericsson (publ), Stockholm (SE)

(21) Appl. No.: 17/593,952

(22) PCT Filed: Mar. 27, 2020
(86) PCT No.: PCT/CN2020/081747

§ 371 Date: Sep. 28, 2021

(30) Foreign Application Priority Data
Mar. 28, 2019 (CN) PCT/CN2019/080275

(51) Int. Cl. H04B 7/06; H04W 72/12

(52) U.S. Cl. CPC H04B 7/0626; H04W 72/1242

(57) ABSTRACT

Methods, a terminal device and a base station are disclosed for resource allocation. The terminal device transmits, to a base station, at least one request for allocating a resource for at least one channel state information (CSI) feedback. The terminal device receives, from the base station, resource allocation of a shared channel in response to the at least one request.

### TECHNICAL FIELD

Embodiments of the disclosure generally relate to wireless communication, and, more particularly, to methods, a terminal device and a base station for resource allocation.

### BACKGROUND

This section introduces aspects that may facilitate better understanding of the present disclosure. Accordingly, the statements of this section are to be read in this light and are not to be understood as admissions about what is in the prior art or what is not in the prior art.

Device-to-device (D2D) communication in cellular networks is defined as direct communication between two terminal devices without traversing the base station or core network. In Release 14 and Release 15 of 3rd generation partnership project (3GPP), the extensions for the D2D work comprise support for vehicle-to-everything (V2X) communication. There are mainly three use cases defined for V2X: vehicle-to-vehicle (V2V), vehicle-to-pedestrian (V2P) and vehicle-to-infrastructure/network (V2I/N). Thus, V2X communication includes any combination of direct communication between vehicles, pedestrians and infrastructure.

Because long term evolution (LTE) has economies of scale and may enable tighter integration between V2I and V2V/V2P communications, providing an LTE-based V2X interface may be economically advantageous, as compared to using a dedicated V2X technology such as institute of electrical and electronics engineers (IEEE) 802.11p. FIG. 1 shows V2X scenarios for an LTE-based network. V2V covers LTE-based communication between vehicles, either via Uu or sidelink. The Uu refers to the cellular interface between a user equipment (UE) and an evolved node B (eNB). The sidelink may refer to a direct communication interface between UEs (also referred to as PC5 interface in LTE). V2P covers LTE-based communication between a vehicle and a device carried by an individual (e.g. handheld terminal carried by a pedestrian, cyclist, driver or passenger), either via Uu or sidelink. V2I/N covers LTE-based communication between a vehicle and a roadside unit/network. A roadside unit (RSU) is a transportation infrastructure entity (e.g. an entity transmitting speed notifications) that communicates with V2X capable UEs over sidelink or over Uu. For V2N, the communication is performed via Uu.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for resource allocation.

According to a first aspect of the disclosure, there is provided a method implemented at a terminal device. The method comprises transmitting, to a base station, at least one request for allocating a resource for at least one lower layer signaling applicable in a layer lower than the layer where a buffer status report is transmitted. The method further comprises receiving, from the base station, resource allocation in response to the at least one request.

In this way, the resource for transmitting the lower layer signaling can be properly scheduled.

In an embodiment of the disclosure, the resource allocated for the at least one lower layer signaling may be a resource of a shared channel.

In an embodiment of the disclosure, each of the at least one request may be transmitted with one of multiple predetermined resources. Each of the multiple predetermined resources may indicate a corresponding configuration of the lower layer signaling.

In an embodiment of the disclosure, one request may be transmitted for multiple lower layer signalings, or multiple requests each of which corresponds to one of multiple lower layer signalings may be transmitted.

In an embodiment of the disclosure, the lower layer signaling may be a periodic signaling, and the at least one request may be transmitted periodically in response to a trigger of the lower layer signaling. Alternatively, the lower layer signaling may be an aperiodic signaling, and the at least one request may be transmitted aperiodically in response to a trigger of the lower layer signaling.

In an embodiment of the disclosure, the lower layer signaling may be a periodic signaling. The method may further comprise providing, to the base station, information related to a periodicity of the lower layer signaling. The method may further comprise receiving, from the base station, resource allocation for the lower layer signaling periodically.

In an embodiment of the disclosure, providing the information to the base station may comprise transmitting, to the base station, information for determining the periodicity. Alternatively, providing the information to the base station may comprise determining the periodicity and informing the base station of the periodicity.

In an embodiment of the disclosure, the method may further comprise, when multiple requests are to be transmitted, determining scheduling priorities for lower layer signalings corresponding to the multiple requests. The method may further comprise prioritizing transmission order of the multiple requests based on the determined scheduling priorities.

In an embodiment of the disclosure, the method may further comprise determining a scheduling priority for the at least one lower layer signaling corresponding to the at least one request. The at least one request may be transmitted based on the determined scheduling priority.

In an embodiment of the disclosure, when at least one second request for allocating a resource for data and the at least one request are transmitted, a scheduling priority for the data corresponding to the at least one second request may be determined. The at least one request and the at least one second request may be transmitted based on the scheduling priorities determined for the at least one lower layer signaling and the data.

In an embodiment of the disclosure, the scheduling priority for a lower layer signaling may be preconfigured as a fixed scheduling priority, or determined based on at least one of: a scheduling priority for data from another terminal device to which the lower layer signaling is to be transmitted; and network load condition.

In an embodiment of the disclosure, the lower layer signaling may be channel state information (CSI) feedback.

In an embodiment of the disclosure, the shared channel may be physical sidelink shared channel (PSSCH).

In an embodiment of the disclosure, the request may be one of: a scheduling request (SR); a medium access control (MAC) control element (CE); and a radio resource control (RRC) signaling.

In an embodiment of the disclosure, the method may further comprise providing user data and forwarding the user data to a host computer via the transmission to the base station.

According to a second aspect of the disclosure, there is provided a method implemented at a base station. The method comprises receiving, from a terminal device, at least one request for allocating a resource for at least one lower layer signaling applicable in a layer lower than the layer where a buffer status report is transmitted. The method further comprises allocating a resource to the terminal device based on the at least one request.

In this way, the resource for transmitting the lower layer signaling can be properly scheduled.

In an embodiment of the disclosure, the resource allocated for the at least one lower layer signaling may be a resource of a shared channel.

In an embodiment of the disclosure, each of the at least one request may be received with one of multiple predetermined resources. Each of the multiple predetermined resources may indicate a corresponding configuration of the lower layer signaling.

In an embodiment of the disclosure, one request may be received for multiple lower layer signalings, or multiple requests each of which corresponds to one of multiple lower layer signalings may be received.

In an embodiment of the disclosure, the lower layer signaling may be a periodic signaling, and the at least one request may be received periodically. Alternatively, the lower layer signaling may be an aperiodic signaling, and the at least one request may be received aperiodically.

In an embodiment of the disclosure, the lower layer signaling may be a periodic signaling. The method may further comprise receiving, from the terminal device, information related to a periodicity of the lower layer signaling. The method may further comprise determining the periodicity based on the received information. The method may further comprise allocating a resource to the terminal device periodically based on the periodicity.

In an embodiment of the disclosure, the information related to the periodicity of the lower layer signaling may be information for determining the periodicity or information indicating the periodicity.

In an embodiment of the disclosure, the lower layer signaling may be CSI feedback.

In an embodiment of the disclosure, the shared channel may be PSSCH.

In an embodiment of the disclosure, the request may be one of: an SR; an MAC CE; and a RRC signaling.

According to a third aspect of the disclosure, there is provided a method implemented at a terminal device. The method comprises determining a scheduling priority for a lower layer signaling applicable in a layer lower than the layer where a buffer status report is transmitted. The method further comprises determining a final scheduling priority for an incoming transmission based at least on the scheduling priority for the lower layer signaling. The method further comprises allocating a resource for the incoming transmission based on the final scheduling priority.

In this way, the resource for transmitting the lower layer signaling can be properly scheduled.

In an embodiment of the disclosure, the resource allocated for the lower layer signaling may be a resource of a shared channel.

In an embodiment of the disclosure, the scheduling priority for the lower layer signaling may be preconfigured as a fixed scheduling priority, or determined based on at least one of: a scheduling priority for data from another terminal device to which the lower layer signaling is to be transmitted; and network load condition.

In an embodiment of the disclosure, determining the final scheduling priority may comprise determining whether the incoming transmission includes transmission of data. Determining the final scheduling priority may further comprise, when the incoming transmission includes transmission of data, determining the final scheduling priority as a higher value of the scheduling priority for the data and the scheduling priority for the lower layer signaling. Determining the final scheduling priority may further comprise, when the incoming transmission includes no transmission of data, determining the final scheduling priority as the scheduling priority for the lower layer signaling.

In an embodiment of the disclosure, the scheduling priority may be expressed by: proximity based services (ProSe) per packet priority (PPPP); or quality of service (QoS) information.

In an embodiment of the disclosure, the lower layer signaling may be CSI feedback.

In an embodiment of the disclosure, the shared channel may be PSSCH.

According to a fourth aspect of the disclosure, there is provided a terminal device. The terminal device comprises at least one processor and at least one memory. The at least one memory contains instructions executable by the at least one processor, whereby the terminal device is operative to transmit, to a base station, at least one request for allocating a resource for at least one lower layer signaling applicable in a layer lower than the layer where a buffer status report is transmitted. The terminal device is further operative to receive, from the base station, resource allocation in response to the at least one request.

In an embodiment of the disclosure, the terminal device may be operative to perform the method according to the above first aspect.

According to a fifth aspect of the disclosure, there is provided a base station. The base station comprises at least one processor and at least one memory. The at least one memory contains instructions executable by the at least one processor, whereby the base station is operative to receive, from a terminal device, at least one request for allocating a resource for at least one lower layer signaling applicable in a layer lower than the layer where a buffer status report is transmitted. The base station is further operative to allocate a resource to the terminal device based on the at least one request.

In an embodiment of the disclosure, the base station may be operative to perform the method according to the above second aspect.

According to a sixth aspect of the disclosure, there is provided a terminal device. The terminal device comprises at least one processor and at least one memory. The at least one memory contains instructions executable by the at least one processor, whereby the terminal device is operative to determine a scheduling priority for a lower layer signaling applicable in a layer lower than the layer where a buffer status report is transmitted. The terminal device is further operative to determine a final scheduling priority for an incoming transmission based at least on the scheduling priority for the lower layer signaling. The terminal device is further operative to allocate a resource for the incoming transmission based on the final scheduling priority.

In an embodiment of the disclosure, the terminal device may be operative to perform the method according to the above third aspect.

According to a seventh aspect of the disclosure, there is provided a computer program product. The computer program product comprises instructions which when executed by at least one processor, cause the at least one processor to perform the method according to any of the above first to third aspects.

According to an eighth aspect of the disclosure, there is provided a computer readable storage medium. The computer readable storage medium comprises instructions which when executed by at least one processor, cause the at least one processor to perform the method according to any of the above first to third aspects.

According to a ninth aspect of the disclosure, there is provided a terminal device. The terminal device comprises a transmission module for transmitting, to a base station, at least one request for allocating a resource for at least one lower layer signaling applicable in a layer lower than the layer where a buffer status report is transmitted. The terminal device further comprises a reception module for receiving, from the base station, resource allocation in response to the at least one request.

According to a tenth aspect of the disclosure, there is provided a base station. The base station comprises a reception module for receiving, from a terminal device, at least one request for allocating a resource for at least one lower layer signaling applicable in a layer lower than the layer where a buffer status report is transmitted. The base station further comprises an allocation module for allocating a resource to the terminal device based on the at least one request.

According to an eleventh aspect of the disclosure, there is provided a terminal device. The terminal device comprises a first determination module for determining a scheduling priority for a lower layer signaling applicable in a layer lower than the layer where a buffer status report is transmitted. The terminal device further comprises a second determination module for determining a final scheduling priority for an incoming transmission based at least on the scheduling priority for the lower layer signaling. The terminal device further comprises an allocation module for allocating a resource for the incoming transmission based on the final scheduling priority.

According to a twelfth aspect of the disclosure, there is provided a method implemented at a terminal device. The method comprises providing, to a base station, information related to a periodicity of the lower layer signaling that is a periodic signaling. The method further comprises receiving, from the base station, resource allocation for the lower layer signaling periodically.

In an embodiment of the disclosure, providing the information to the base station may comprise transmitting, to the base station, information for determining the periodicity. Alternatively, providing the information to the base station may comprise determining the periodicity and informing the base station of the periodicity.

According to a thirteenth aspect of the disclosure, there is provided a method implemented at a base station. The method comprises receiving, from a terminal device, information related to a periodicity of the lower layer signaling that is a periodic signaling. The method further comprises determining the periodicity based on the received information. The method further comprises allocating a resource to the terminal device periodically based on the periodicity.

In an embodiment of the disclosure, the information related to the periodicity of the lower layer signaling may be information for determining the periodicity or information indicating the periodicity.

According to a fourteenth aspect of the disclosure, there is provided a terminal device. The terminal device comprises at least one processor and at least one memory. The at least one memory contains instructions executable by the at least one processor, whereby the terminal device is operative to provide, to the base station, information related to a periodicity of the lower layer signaling that is a periodic signaling. The terminal device is further operative to receive, from the base station, resource allocation for the lower layer signaling periodically.

According to a fifteenth aspect of the disclosure, there is provided a base station. The base station comprises at least one processor and at least one memory. The at least one memory contains instructions executable by the at least one processor, whereby the base station is operative to receive, from the terminal device, information related to a periodicity of the lower layer signaling that is a periodic signaling. The base station is further operative to determine the periodicity based on the received information. The base station is further operative to allocate a resource to the terminal device periodically based on the periodicity.

According to a sixteenth aspect of the disclosure, there is provided a terminal device. The terminal device comprises a provision module for providing, to a base station, information related to a periodicity of the lower layer signaling that is a periodic signaling. The terminal device further comprises a reception module for receiving, from the base station, resource allocation for the lower layer signaling periodically.

According to a seventeenth aspect of the disclosure, there is provided a base station. The base station comprises a reception module for receiving, from a terminal device, information related to a periodicity of the lower layer signaling that is a periodic signaling. The base station further comprises a determination module for determining the periodicity based on the received information. The base station further comprises an allocation module for allocating a resource to the terminal device periodically based on the periodicity.

According to an eighteenth aspect of the disclosure, there is provided a method implemented in a communication system including a host computer, a base station and a terminal device. The method comprises, at the host computer, providing user data. The method further comprises, at the host computer, initiating a transmission carrying the user data to the terminal device via a cellular network comprising the base station. The base station receives, from a terminal device, at least one request for allocating a resource for at least one lower layer signaling applicable in a layer lower than the layer where a buffer status report is transmitted. The base station allocates a resource to the terminal device based on the at least one request.

In an embodiment of the disclosure, the method may further comprise, at the base station, transmitting the user data.

In an embodiment of the disclosure, the user data may be provided at the host computer by executing a host application. The method may further comprise, at the terminal device, executing a client application associated with the host application.

According to a nineteenth aspect of the disclosure, there is provided a communication system including a host computer comprising processing circuitry configured to provide user data and a communication interface configured to forward the user data to a cellular network for transmission to a terminal device. The cellular network comprises a base station having a radio interface and processing circuitry. The base station's processing circuitry is configured to receive, from a terminal device, at least one request for allocating a resource for at least one lower layer signaling applicable in a layer lower than the layer where a buffer status report is transmitted. The base station's processing circuitry is further configured to allocate a resource to the terminal device based on the at least one request.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application, thereby providing the user data. The terminal device may comprise processing circuitry configured to execute a client application associated with the host application.

According to a twentieth aspect of the disclosure, there is provided a method implemented in a communication system including a host computer, a base station and a terminal device. The method comprises, at the host computer, providing user data. The method further comprises, at the host computer, initiating a transmission carrying the user data to the terminal device via a cellular network comprising the base station. The terminal device transmits, to a base station, at least one request for allocating a resource for at least one lower layer signaling applicable in a layer lower than the layer where a buffer status report is transmitted. The terminal device receives, from the base station, resource allocation in response to the at least one request.

In an embodiment of the disclosure, the method may further comprise, at the terminal device, receiving the user data from the base station.

According to a twenty-first aspect of the disclosure, there is provided a communication system including a host computer comprising processing circuitry configured to provide user data and a communication interface configured to forward user data to a cellular network for transmission to a terminal device. The terminal device comprises a radio interface and processing circuitry. The processing circuitry of the terminal device is configured to transmit, to a base station, at least one request for allocating a resource for at least one lower layer signaling applicable in a layer lower than the layer where a buffer status report is transmitted. The processing circuitry of the terminal device is configured to receive, from the base station, resource allocation in response to the at least one request.

In an embodiment of the disclosure, the communication system may further include the terminal device.

In an embodiment of the disclosure, the cellular network may further include a base station configured to communicate with the terminal device.

In an embodiment of the disclosure, the processing circuitry of the host computer may be configured to execute a host application, thereby providing the user data. The processing circuitry of the terminal device may be configured to execute a client application associated with the host application.

According to a twenty-second aspect of the disclosure, there is provided a method implemented in a communication system including a host computer, a base station and a terminal device. The method comprises, at the host computer, receiving user data transmitted to the base station from the terminal device. The terminal device transmits, to a base station, at least one request for allocating a resource for at least one lower layer signaling applicable in a layer lower than the layer where a buffer status report is transmitted. The terminal device receives, from the base station, resource allocation in response to the at least one request.

In an embodiment of the disclosure, the method may further comprise, at the terminal device, providing the user data to the base station.

In an embodiment of the disclosure, the method may further comprise, at the terminal device, executing a client application, thereby providing the user data to be transmitted. The method may further comprise, at the host computer, executing a host application associated with the client application.

In an embodiment of the disclosure, the method may further comprise, at the terminal device, executing a client application. The method may further comprise, at the terminal device, receiving input data to the client application. The input data may be provided at the host computer by executing a host application associated with the client application. The user data to be transmitted may be provided by the client application in response to the input data.

According to a twenty-third aspect of the disclosure, there is provided a communication system including a host computer comprising a communication interface configured to receive user data originating from a transmission from a terminal device to a base station. The terminal device comprises a radio interface and processing circuitry. The processing circuitry of the terminal device is configured to transmit, to a base station, at least one request for allocating a resource for at least one lower layer signaling applicable in a layer lower than the layer where a buffer status report is transmitted. The processing circuitry of the terminal device is further configured to receive, from the base station, resource allocation in response to the at least one request.

In an embodiment of the disclosure, the communication system may further include the terminal device.

In an embodiment of the disclosure, the communication system may further include the base station. The base station may comprise a radio interface configured to communicate with the terminal device and a communication interface configured to forward to the host computer the user data carried by a transmission from the terminal device to the base station.

In an embodiment of the disclosure, the processing circuitry of the host computer may be configured to execute a host application. The processing circuitry of the terminal device may be configured to execute a client application associated with the host application, thereby providing the user data.

In an embodiment of the disclosure, the processing circuitry of the host computer may be configured to execute a host application, thereby providing request data. The processing circuitry of the terminal device may be configured to execute a client application associated with the host application, thereby providing the user data in response to the request data.

According to a twenty-fourth aspect of the disclosure, there is provided a method implemented in a communication system including a host computer, a base station and a terminal device. The method comprises, at the host computer, receiving, from the base station, user data originating from a transmission which the base station has received from the terminal device. The base station receives, from a terminal device, at least one request for allocating a resource for at least one lower layer signaling applicable in a layer lower than the layer where a buffer status report is transmitted. The base station allocates a resource to the terminal device based on the at least one request.

In an embodiment of the disclosure, the method may further comprise, at the base station, receiving the user data from the terminal device.

In an embodiment of the disclosure, the method may further comprise, at the base station, initiating a transmission of the received user data to the host computer.

According to a twenty-fifth aspect of the disclosure, there is provided a communication system including a host computer comprising a communication interface configured to receive user data originating from a transmission from a terminal device to a base station. The base station comprises a radio interface and processing circuitry. The base station's processing circuitry is configured to receive, from a terminal device, at least one request for allocating a resource for at least one lower layer signaling applicable in a layer lower than the layer where a buffer status report is transmitted. The base station's processing circuitry is further configured to allocate a resource to the terminal device based on the at least one request.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

According to a twenty-sixth aspect of the disclosure, there is provided a method implemented in a communication system including a base station and at least one terminal device. The method comprises, at the at least one terminal device, transmitting, to the base station, at least one request for allocating a resource for at least one lower layer signaling applicable in a layer lower than the layer where a buffer status report is transmitted. The method further comprises, at the base station, receiving, from the at least one terminal device, the at least one request for allocating the resource for the at least one lower layer signaling. The method further comprises, at the base station, allocating the resource to the terminal device based on the at least one request. The method further comprises, at the least one terminal device, receiving, from the base station, resource allocation in response to the at least one request.

According to a twenty-seventh aspect of the disclosure, there is provided a communication system comprising at least one terminal device and a base station. The at least one terminal device is configured to transmit, to a base station, at least one request for allocating a resource for at least one lower layer signaling applicable in a layer lower than the layer where a buffer status report is transmitted, and receive, from the base station, resource allocation in response to the at least one request. The base station is configured to receive, from the at least one terminal device, the at least one request for allocating the resource for the at least one lower layer signaling, and allocate the resource to the terminal device based on the at least one request.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 shows V2X scenarios for an LTE-based network;

FIG. 2 is a flowchart illustrating a method implemented at a terminal device according to an embodiment of the disclosure;

FIG. 3 is a flowchart illustrating a method implemented at a terminal device according to another embodiment of the disclosure;

FIG. 4 is a flowchart for explaining the method of FIG. 3;

FIG. 5 is a flowchart illustrating a method implemented at a terminal device according to another embodiment of the disclosure;

FIG. 6 is a flowchart illustrating a method implemented at a base station according to an embodiment of the disclosure;

FIG. 7 is a flowchart illustrating a method implemented at a base station according to another embodiment of the disclosure;

FIG. 8 is a flowchart illustrating a method implemented at a terminal device according to another embodiment of the disclosure;

FIG. 9 is a flowchart for explaining the method of FIG. 8;

FIG. 10 is a block diagram showing an apparatus suitable for use in practicing some embodiments of the disclosure;

FIG. 11 is a block diagram showing a terminal device according to an embodiment of the disclosure;

FIG. 12 is a block diagram showing a base station according to an embodiment of the disclosure;

FIG. 13 is a block diagram showing a terminal device according to another embodiment of the disclosure;

FIG. 14 is a diagram showing a telecommunication network connected via an intermediate network to a host computer in accordance with some embodiments;

FIG. 15 is a diagram showing a host computer communicating via a base station with a user equipment in accordance with some embodiments;

FIG. 16 is a flowchart illustrating a method implemented in a communication system in accordance with some embodiments;

FIG. 17 is a flowchart illustrating a method implemented in a communication system in accordance with some embodiments;

FIG. 18 is a flowchart illustrating a method implemented in a communication system in accordance with some embodiments; and

FIG. 19 is a flowchart illustrating a method implemented in a communication system in accordance with some embodiments.

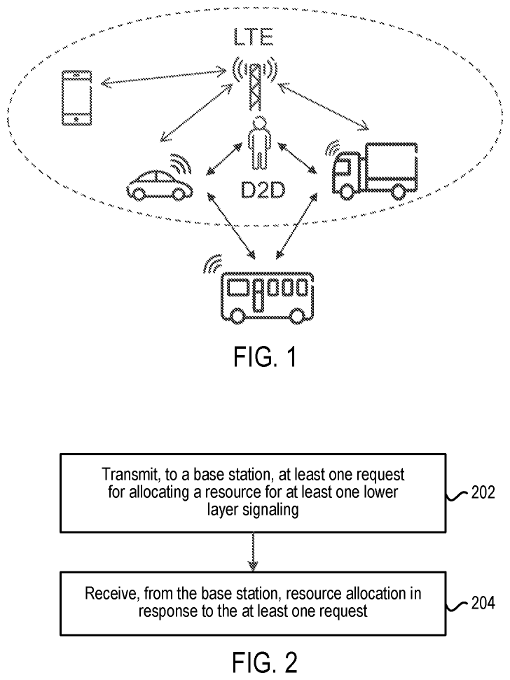

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

References in the specification to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Some of the embodiments described separately or independently hereafter may also be implemented in combination depending on various application scenarios.

The logical channel prioritization procedure is applied when a new transmission is performed. Each sidelink logical channel has an associated priority which is called proximity based services (ProSe) per packet priority (PPPP). Multiple sidelink logical channels may have the same associated priority. PPPP is provided by the higher layer to access stratum (AS) layer. The packet delay budget (PDB) of the protocol data unit (PDU) can be determined from the PPPP. The low PDB is mapped to the high priority PPPP value.

There are two different resource allocation (RA) procedures for V2X on sidelink, i.e. centralized RA (so called “mode 3” in LTE and “mode 1” in new radio (NR)) and autonomous RA (so called “mode 4” in LTE and “mode 2” in NR). The transmission resources are selected within a resource pool which is predefined or configured by the network (NW).

With centralized RA, the sidelink radio resource for data transmission is scheduled/allocated by the NW. The UE sends sidelink buffer status report (BSR) to the NW to inform sidelink data available for transmission in the sidelink buffers associated with the MAC entity, and the NW signals the resource allocation to the UE using downlink control information (DCI) format 5/5A. With distributed RA, each device independently decides which radio resources to use for each transmission based on e.g. sensing. For both RA modes a sidelink control information (SCI) is transmitted on physical sidelink control channel (PSCCH) to indicate the assigned sidelink resources for physical sidelink shared channel (PSSCH).

Sensing is based on decoding of SCI and reference signal receiving power (RSRP) measurement of PSSCH from surrounding UEs. SCI indicates the scheduling priority, which is the lowest PPPP (i.e. highest priority) of all the logical channels contained in the MAC PDU. A resource is regarded as free if the measured RSRP from the surrounding UEs scaled by the PPPP of the UE performing sensing and the PPPP of the UE being sensed is lower than a threshold. The measured RSRP is scaled down if the UE performing sensing has lower PPPP (i.e. higher priority). Correspondingly the resource is more likely to be regarded as free and used by the UE. The details may be obtained from 3GPP technical specification (TS) 36.213 V15.4.0, section 14.1.1.6.

3GPP SA1 working group has completed new service requirements for future V2X services in the FS eV2X. The term “SA” refers to standalone, the term “FS” refers to feasibility study and the term “eV2X” refers to enhanced V2X. The SA1 working group has identified 25 use cases for advanced V2X services which will be used in 5G (e.g. LTE and NR). Such use cases are categorized into four use case groups: vehicles platooning, extended sensors, advanced driving and remote driving. Direct unicast transmission over sidelink will be needed in some use cases such as platooning, cooperative driving, dynamic ride sharing, etc.

The consolidated requirements for each use case group are captured in technical report (TR) 22.886. For these advanced applications, the expected requirements to meet the needed data rate, capacity, reliability, latency, communication range and speed are made more stringent. In order to meet these requirements, some improvements (for example, link adaption for sidelink based on e.g. CSI feedback, more hybrid automatic repeat request (HARQ) processes and adaptive HARQ retransmissions for sidelink based on HARQ feedback, etc.) need to be introduced.

It has already been agreed to introduce sidelink CSI feedback (at least) for sidelink unicast, and the CSI feedback could be delivered using PSSCH (including PSSCH containing CSI only).

For centralized RA, the UE needs to send sidelink BSR to the NW to inform the buffer status associated with the MAC entity. However, CSI feedback is a layer 1 (L1) signaling which is below MAC, thus BSR cannot be used to indicate the number of bits that will be included in a CSI feedback and consequently the NW cannot properly allocate resource for PSSCH containing CSI feedback, especially in case the PSSCH contains CSI feedback only.

Besides, PPPP is provided by the higher layer associated with the data packet. The higher layer cannot provide PPPP for a L1 signaling such as CSI feedback. Due to this, the distributed RA based on sensing cannot work properly when PSSCH contains CSI feedback, as PPPP in the SCI cannot be properly set.

The present disclosure proposes an improved solution for resource allocation. The solution may be applied to a wireless communication system including a terminal device and a base station. The terminal device can communicate through a radio access communication link with the base station. The base station can provide radio access communication links to terminal devices that are within its communication service cell. The base station may be, for example, an eNB in LTE or a gNB in NR. Note that the communications may be performed between the terminal device and the base station according to any suitable communication standards and protocols. The terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

Now, several embodiments will be described to explain the improved solution for resource allocation. As the first embodiment, a UE informs the NW that resources are needed for transmitting sidelink CSI and the NW schedules transmission resources for PSSCH containing CSI feedback. In this way, the resources for transmitting sidelink CSI can be properly scheduled.

For example, a (sidelink) CSI specific scheduling request (SR) may be introduced to inform the NW that a sidelink CSI feedback needs to be sent over PSSCH. Dedicated SR resources may be configured for CSI specific SR. Optionally, multiple SR resources may be configured for this CSI specific SR, and each SR resource indicates a certain CSI feedback configuration. For instance, whether the CSI feedback is a wideband or subband feedback; what will be reported in the CSI feedback (e.g. channel quality indicator (CQI), and/or rank indication (RI), and/or precoding matrix indicator (PMI)), etc. Alternatively, each SR resource may just indicate the number of bits that will be included in the CSI feedback.

For periodic CSI feedback, the CSI specific SR may be triggered when the timer for triggering periodic CSI feedback expires or is going to expire. For aperiodic CSI feedback, the CSI specific SR may be triggered by the receiving (Rx) UE (i.e. the UE which sends the CSI feedback) upon reception of a request for sending the CSI feedback from the transmitting (Tx) UE, and/or the measured quality of sidelink (SL) channel state information reference signal (CSI-RS) becomes worse than a certain threshold or the variation exceeds a certain threshold, and/or the speed of the Rx UE becomes higher than a certain threshold or the variation exceeds a certain threshold, etc.

In case multiple CSI feedbacks need to be transmitted concurrently (e.g. from the same Rx UE to multiple Tx UEs), multiple CSI specific SRs each of which corresponds to one CSI feedback, may be sent, or a single CSI specific SR may be sent for all the CSI feedbacks. In the latter case, the SR may indicate e.g. the total number of bits that will be included in all the CSI feedbacks.

As an alternative option, for periodic CSI feedback, the NW may book (or reserve) the resources for PSSCH containing the CSI feedback based on the CSI feedback periodicity, without the need for the UE to explicitly inform the NW that a CSI feedback needs to be transmitted over sidelink. In this case, the CSI specific SR may be only sent when aperiodic CSI feedback(s) are triggered. The periodicity may be determined based on e.g. the UE speed, the service QoS requirements, the UE capabilities (e.g. the maximum rank that can be supported by the Tx UE and the Rx UE), etc. Optionally, The UE may report the above assistance information to the NW and the NW may configure the CSI feedback periodicity taking the assistance information into account, in which case the periodicity needs not to be explicitly informed to the UE. Alternatively, the CSI feedback periodicity may be configured by the UE and then informed to the NW.

Optionally, the NW may indicate to the UE, via either RRC signaling or in DCI, that a certain sidelink grant is for PSSCH containing (only) CSI feedback. Optionally, the UE may also inform the NW by a dedicated signaling that a sidelink CSI feedback is triggered and needs to be transmitted, and optionally also the configurations or the number of bits of the CSI feedback. For instance, the dedicated signaling may be an MAC control element (CE) or a RRC signaling.

As a second embodiment, scheduling priority may be assigned for (sidelink) CSI feedback. As CSI is a L1 signaling, its scheduling priority cannot be obtained from higher layer. To solve this, at least one of the following options may be used to assign a scheduling priority for CSI. As the first option, a fixed scheduling priority may be assigned for CSI feedback. As an exemplary example, the lowest scheduling priority may be assigned for CSI feedback so that data transmission is always prioritized over CSI feedback. The priority may be configured by the NW or preconfigured in the UE. As the second option, the scheduling priority of CSI feedback may be set based on the priority of data from the Tx UE to which the CSI feedback will be sent. Thus, data with higher priority will obtain the CSI report more quickly. As the third option, the scheduling priority may be adjusted based on network load condition, e.g. channel busy ratio (CBR). A lower scheduling priority may be assigned if the CBR becomes higher.

Optionally, the priority may also be applied in determining which SR to be sent if multiple CSI specific SRs need to be sent. In this case, the priority of CSI specific SR may be set based on the scheduling priority of the CSI feedback that the CSI specific SR corresponds to. The CSI specific SR with higher priority may be transmitted first. Likewise, since the scheduling priority of CSI feedback may be set relative to the scheduling priority of data transmission as described above, when one or more SRs for data transmission and one or more CSI specific SRs need to be sent, their priorities may be applied in determining which SR to be sent first. Similar to the determination of the priority of the CSI specific SR, the priority of the SR for data transmission may be set based on the scheduling priority of the data corresponding to this SR. That is, the determination of the scheduling priority of CSI feedback may be performed no matter there is one or multiple CSI specific SRs, since some of the SRs may be for data transmission while some others may be for CSI feedback.

In both the first and second embodiments above, the sidelink CSI may be transmitted using a separate PSSCH no matter there is data to be transmitted or not. In this case, a separate SCI may be used to indicate the Tx resources for PSSCH containing only CSI feedback. In case PSSCH could contain both data and CSI feedback, the scheduling priority in SCI may be set to the higher scheduling priority of data and CSI feedback.

Although the above embodiments have been described in a context of LTE, the principle of the present disclosure can also be applied to NR or any radio access technology (RAT). Furthermore, although the above embodiments have been described by using CSI feedback transmitted on PSSCH as an example, the principle of the present disclosure can also be applied to scheduling of any other lower layer signaling (below MAC layer) transmitted on any other shared channel.

Hereinafter, the solution will be further described with reference to FIGS. 2-19. FIG. 2 is a flowchart illustrating a method implemented at a terminal device according to an embodiment of the disclosure. At block 202, the terminal device transmits, to a base station, at least one request for allocating a resource for at least one lower layer signaling applicable in a layer lower than the layer where a buffer status report (BSR) is transmitted. At block 204, the terminal device receives, from the base station, resource allocation in response to the at least one request. In this way, the resource for transmitting the lower layer signaling can be properly scheduled.

For example, the lower layer signaling may be channel state information (CSI) feedback. The resource allocated for the at least one lower layer signaling may be a resource of a shared channel such as PSSCH. Examples of the request may be, but not limited to, a scheduling request (SR), an MAC control element (CE), and a RRC signaling.

Optionally, each of the at least one request may be transmitted with one of multiple predetermined resources. Each of the multiple predetermined resources may indicate a corresponding configuration of the lower layer signaling. In the above example of CSI feedback, an indicated configuration of the CSI feedback may be related to one or more of: whether the CSI feedback is a wideband or subband feedback; the type of information which will be reported in the CSI feedback; the number of bits that will be included in the CSI feedback.

For example, in a case that multiple lower layer signalings need to be transmitted concurrently, one request may be transmitted for the multiple lower layer signalings or multiple requests each of which corresponds to one of the multiple lower layer signalings may be transmitted.

Optionally, the lower layer signaling may be a periodic signaling, and the at least one request may be transmitted periodically in response to a trigger of the lower layer signaling. For example, such trigger may be an event that a timer for triggering the periodic signaling expires or is to expire. Alternatively, the lower layer signaling may be an aperiodic signaling, and the at least one request may be transmitted aperiodically in response to a trigger of the lower layer signaling. For example, such trigger may be one or more of the following events: the terminal device receives from another terminal device a request for sending the lower layer signaling; the measured quality of a reference signal becomes worse than a predetermined threshold; the variation of the measured quality exceeds a predetermined threshold; the speed of the terminal device becomes higher than a predetermined threshold or the variation thereof exceeds a predetermined threshold.

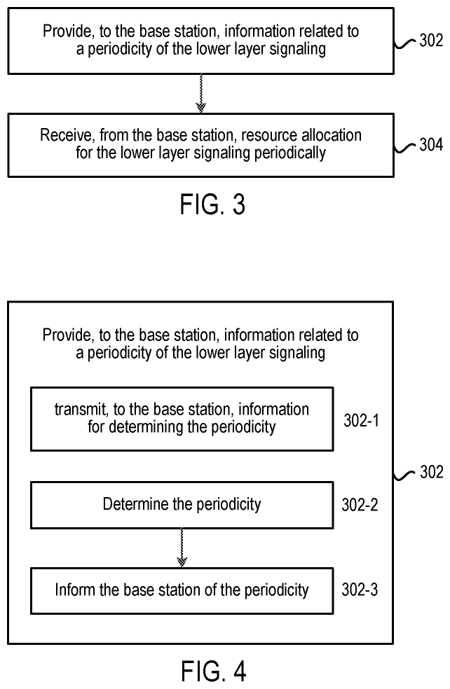

FIG. 3 is a flowchart illustrating a method implemented at a terminal device according to another embodiment of the disclosure. The method may be used for scheduling the resource for transmitting a lower layer signaling which is a periodic signaling applicable in a layer lower than the layer where a BSR is transmitted. At block 302, the terminal device provides, to a base station, information related to a periodicity of the lower layer signaling. For example, block 302 may be implemented as block 302-1 or blocks 302-2˜302-3 as shown in FIG. 4. At block 302-1, the terminal device transmits, to the base station, information for determining the periodicity. Examples of such information may include, but not limited to, the speed, the service QoS requirements, and the capabilities of the terminal device. In this way, the base station can determine the periodicity base on such information. Alternatively, at block 302-2, the terminal device determines the periodicity. This determination may be made based on the information listed above. At block 302-3, the terminal device informs the base station of the periodicity. At block 304, the terminal device receives, from the base station, resource allocation for the lower layer signaling periodically. In this way, there is no need for the terminal device to transmit a request for resource allocation for the lower layer signaling to the base station periodically.

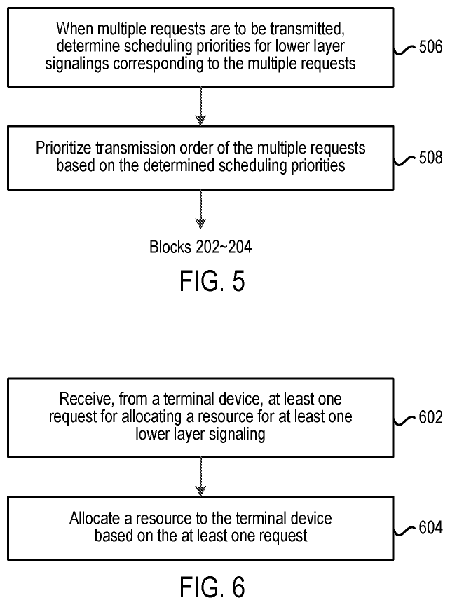

FIG. 5 is a flowchart illustrating a method implemented at a terminal device according to another embodiment of the disclosure. As shown, the method comprises blocks 506-508 and 202-204. At block 506, when multiple requests are to be transmitted, the terminal device determines scheduling priorities for lower layer signalings corresponding to the multiple requests. The scheduling priority for a lower layer signaling may be preconfigured as a fixed scheduling priority. Alternatively, the scheduling priority for a lower layer signaling may be determined based on at least one of: a scheduling priority for data from another terminal device to which the lower layer signaling is to be transmitted; and network load condition. At block 508, the terminal device prioritizes transmission order of the multiple requests based on the determined scheduling priorities. A request corresponding to a higher priority may be transmitted preferentially relative to a request corresponding to a lower priority. Then, blocks 202 and 204 are performed. Details of these blocks are omitted here for brevity.

As mentioned above, the determination of the scheduling priority of CSI feedback may be performed no matter there is one or multiple CSI specific SRs, since some of the SRs may be for data transmission while some others may be for CSI feedback. Therefore, at least one embodiment of the disclosure provides a method in a terminal device. The method comprises determining a scheduling priority for the at least one lower layer signaling corresponding to the at least one request. The method further comprises blocks 202 and 204. In this embodiment, the at least one request is transmitted at block 202 based on the determined scheduling priority.

As an exemplary example, when at least one second request for allocating a resource for data and the at least one request are transmitted, the terminal device may determine a scheduling priority for the data corresponding to the at least one second request. The at least one request and the at least one second request may be transmitted based on the scheduling priorities determined for the at least one lower layer signaling and the data.

FIG. 6 is a flowchart illustrating a method implemented at a base station according to an embodiment of the disclosure. At block 602, the base station receives, from a terminal device, at least one request for allocating a resource for at least one lower layer signaling applicable in a layer lower than the layer where a buffer status report is transmitted. Block 602 corresponds to block 202 and its details are omitted here. At block 604, the base station allocates a resource to the terminal device based on the at least one request. In this way, the resource for transmitting the lower layer signaling can be properly scheduled. Note that the present disclosure is not limited in the implementation details of block 604.

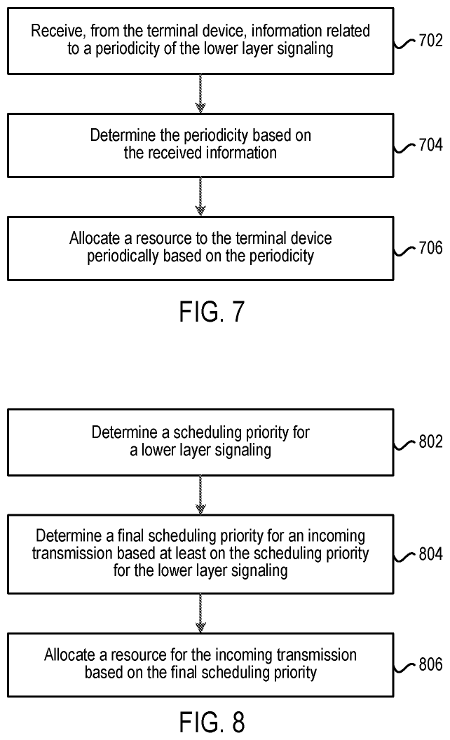

FIG. 7 is a flowchart illustrating a method implemented at a base station according to another embodiment of the disclosure. The method may be used for scheduling the resource for transmitting a lower layer signaling which is a periodic signaling applicable in a layer lower than the layer where a BSR is transmitted. At block 802, the base station receives, from a terminal device, information related to a periodicity of the lower layer signaling. For example, the information related to the periodicity of the lower layer signaling may be information for determining the periodicity or information indicating the periodicity. At block 804, the base station determines the periodicity based on the received information. At block 806, the base station allocates a resource to the terminal device periodically based on the periodicity. In this way, there is no need for the terminal device to transmit a request for resource allocation for the lower layer signaling to the base station periodically.

FIG. 8 is a flowchart illustrating a method implemented at a terminal device according to another embodiment of the disclosure. At block 802, the terminal device determines a scheduling priority for a lower layer signaling applicable in a layer lower than the layer where a buffer status report is transmitted. For example, the lower layer signaling may be CSI feedback. The resource scheduled for the at least one lower layer signaling may be a resource of a shared channel such as PSSCH. For example, the scheduling priority may be expressed by proximity based services (ProSe) per packet priority (PPPP) in LTE or Qos information in NR. Optionally, the scheduling priority for the lower layer signaling may be preconfigured as a fixed scheduling priority. Alternatively, the scheduling priority for the lower layer signaling may be determined based on at least one of: a scheduling priority for data from another terminal device to which the lower layer signaling is to be transmitted; and network load condition.

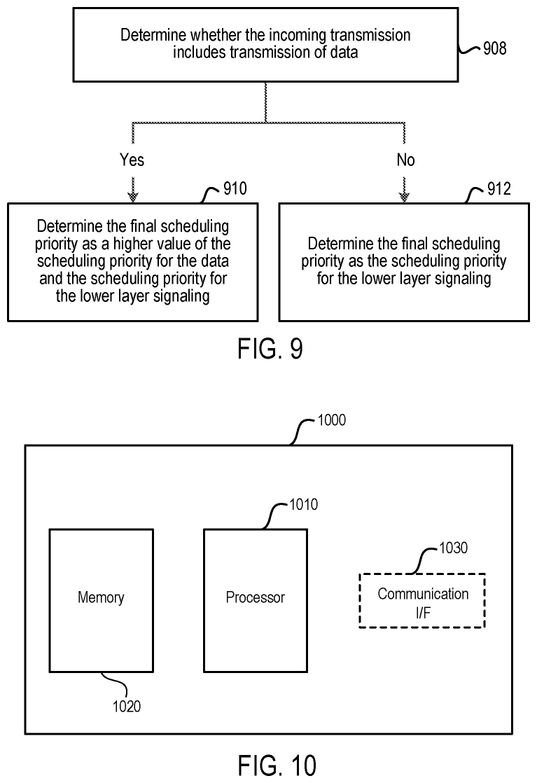

At block 804, the terminal device determines a final scheduling priority for an incoming transmission based at least on the scheduling priority for the lower layer signaling. For example, block 804 may be implemented as blocks 908-912 of FIG. 9. At block 908, the terminal device determines whether the incoming transmission includes transmission of data. The incoming transmission is the transmission which is to be transmitted by the terminal device. If it is determined at block 908 that the incoming transmission includes transmission of data, the terminal device determines the final scheduling priority as a higher value of the scheduling priority for the data and the scheduling priority for the lower layer signaling at block 910. On the other hand, if it is determined at block 908 that the incoming transmission includes no transmission of data, the terminal device determines the final scheduling priority as the scheduling priority for the lower layer signaling.

At block 806, the terminal device allocates a resource for the incoming transmission based on the final scheduling priority. As an exemplary example, in the case of CSI feedback transmitted on PSSCH, the terminal device may perform sensing and determine whether a resource is free based on the final scheduling priority (determined at block 804) and the sensed result (e.g. RSRP and PPPP from a surrounding terminal device). This may be similar to the process described in 3GPP TS 36.213 V15.4.0, section 14.1.1.6. It should be noted that two blocks shown in succession in the figures may, in fact, be executed substantially concurrently, or the blocks may sometimes be executed in the reverse order, depending upon the functionality involved.

Based on the above description, at least one aspect of the disclosure provides a method implemented in a communication system including a base station and at least one terminal device. The method comprises, at the at least one terminal device, transmitting, to the base station, at least one request for allocating a resource for at least one lower layer signaling applicable in a layer lower than the layer where a buffer status report is transmitted. The method further comprises, at the base station, receiving, from the at least one terminal device, the at least one request for allocating the resource for the at least one lower layer signaling. The method further comprises, at the base station, allocating the resource to the terminal device based on the at least one request. The method further comprises, at the least one terminal device, receiving, from the base station, resource allocation in response to the at least one request.

FIG. 10 is a block diagram showing an apparatus suitable for use in practicing some embodiments of the disclosure. For example, any one of the terminal device and the base station described above may be implemented through the apparatus 1000. As shown, the apparatus 1000 may include a processor 1010, a memory 1020 that stores a program, and optionally a communication interface 1030 for communicating data with other external devices through wired and/or wireless communication.

The program includes program instructions that, when executed by the processor 1010, enable the apparatus 1000 to operate in accordance with the embodiments of the present disclosure, as discussed above. That is, the embodiments of the present disclosure may be implemented at least in part by computer software executable by the processor 1010, or by hardware, or by a combination of software and hardware.

The memory 1020 may be of any type suitable to the local technical environment and may be implemented using any suitable data storage technology, such as semiconductor based memory devices, flash memories, magnetic memory devices and systems, optical memory devices and systems, fixed memories and removable memories. The processor 1010 may be of any type suitable to the local technical environment, and may include one or more of general purpose computers, special purpose computers, microprocessors, digital signal processors (DSPs) and processors based on multi-core processor architectures, as non-limiting examples.

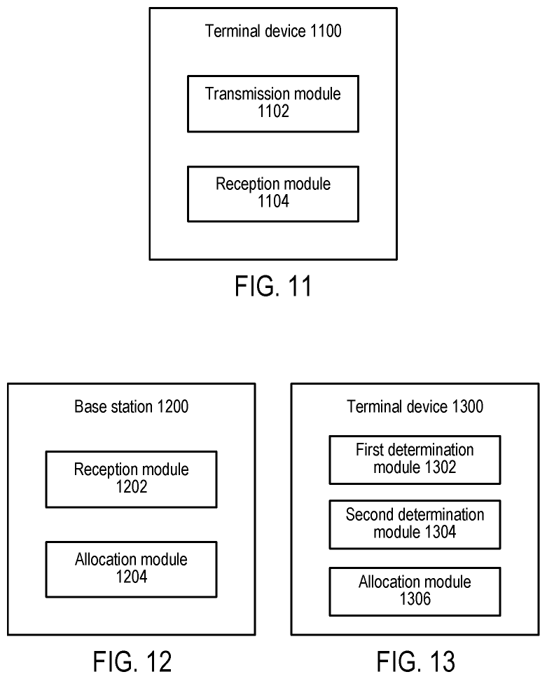

FIG. 11 is a block diagram showing a terminal device according to an embodiment of the disclosure. As shown, the terminal device 1100 comprises a transmission module 1102 and a reception module 1104. The transmission module 1102 may be configured to transmit, to a base station, at least one request for allocating a resource for at least one lower layer signaling applicable in a layer lower than the layer where a buffer status report is transmitted, as described above with respect to block 202. The reception module 1104 may be configured to receive, from the base station, resource allocation in response to the at least one request, as described above with respect to block 204.

FIG. 12 is a block diagram showing a base station according to an embodiment of the disclosure. As shown, the base station 1200 comprises a reception module 1202 and an allocation module 1204. The reception module 1202 may be configured to receive, from a terminal device, at least one request for allocating a resource for at least one lower layer signaling applicable in a layer lower than the layer where a buffer status report is transmitted, as described above with respect to block 602. The allocation module may be configured to allocate a resource to the terminal device based on the at least one request, as described above with respect to block 604.

FIG. 13 is a block diagram showing a terminal device according to another embodiment of the disclosure. As shown, the terminal device 1300 comprises a first determination module 1302, a second determination module 1304 and an allocation module 1306. The first determination module 1302 may be configured to determine a scheduling priority for a lower layer signaling applicable in a layer lower than the layer where a buffer status report is transmitted, as described above with respect to block 702. The second determination module 1304 may be configured to determine a final scheduling priority for an incoming transmission based at least on the scheduling priority for the lower layer signaling, as described above with respect to block 704. The allocation module 1306 may be configured to allocate a resource for the incoming transmission based on the final scheduling priority, as described above with respect to block 706. The modules described above may be implemented by hardware, or software, or a combination of both.

Based on the above description, at least one aspect of the disclosure provides a communication system comprising at least one terminal device and a base station. The at least one terminal device is configured to transmit, to a base station, at least one request for allocating a resource for at least one lower layer signaling applicable in a layer lower than the layer where a buffer status report is transmitted, and receive, from the base station, resource allocation in response to the at least one request. The base station is configured to receive, from the at least one terminal device, the at least one request for allocating the resource for the at least one lower layer signaling, and allocate the resource to the terminal device based on the at least one request.

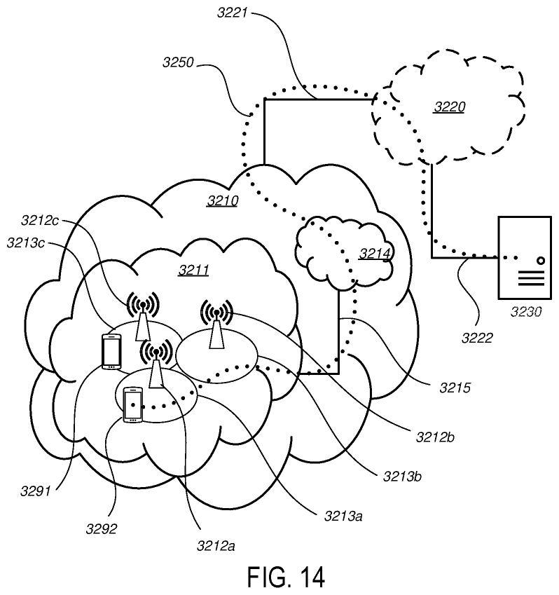

With reference to FIG. 14, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 14 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

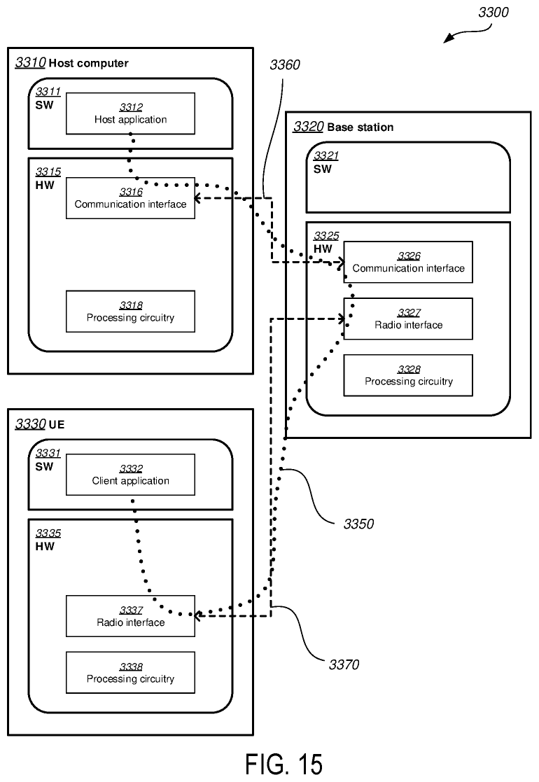

Example implementations, in accordance with an embodiment, of the UE, base station and host computer discussed in the preceding paragraphs will now be described with reference to FIG. 15. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 15) served by base station 3320. Communication interface 3326 may be configured to facilitate connection 3360 to host computer 3310. Connection 3360 may be direct or it may pass through a core network (not shown in FIG. 15) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3335 may include radio interface 3337 configured to set up and maintain wireless connection 3370 with a base station serving a coverage area in which UE 3330 is currently located. Hardware 3335 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 15 may be similar or identical to host computer 3230, one of base stations 3212a, 3212b, 3212c and one of UEs 3291, 3292 of FIG. 14, respectively. This is to say, the inner workings of these entities may be as shown in FIG. 15 and independently, the surrounding network topology may be that of FIG. 14.

In FIG. 15, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the latency and thereby provide benefits such as reduced user waiting time.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

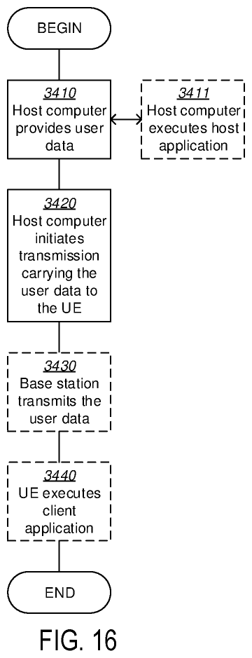

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

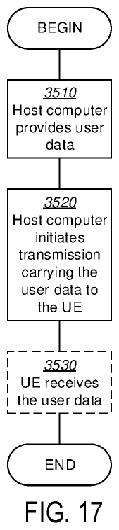

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

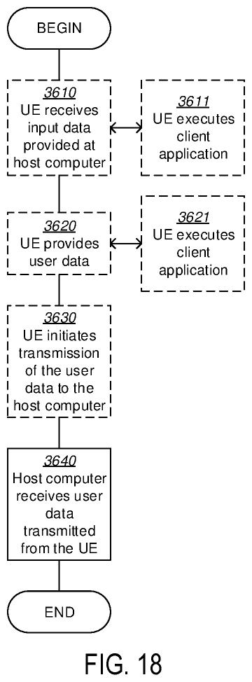

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

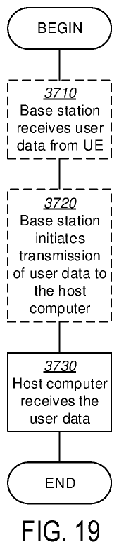

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/ or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method in a terminal device comprising:
transmitting, to a base station, at least one request for allocating a resource for at least one channel state information (CSI) feedback; and
receiving, from the base station, resource allocation of a shared channel in response to the at least one request.

2. The method according to claim 1, wherein each of the at least one request is transmitted according to a corresponding configuration of the CSI feedback.

3. The method according to claim 2, wherein each of the at least one request is transmitted with one of multiple predetermined resources; and wherein each of the multiple predetermined resources indicates a corresponding configuration of the CSI feedback.

4. The method according to claim 1, wherein one request is transmitted for multiple CSI feedbacks.

5. The method according to claim 1, wherein the CSI feedback is an aperiodic signaling, and the at least one request is transmitted aperiodically in response to a trigger of the CSI feedback.

6-8. (canceled)

9. The method according to claim 1, further comprising:
determining a scheduling priority for the at least one CSI feedback corresponding to the at least one request; and
wherein the at least one request is transmitted based on the determined scheduling priority.

10. The method according to claim 9, wherein when at least one second request for allocating a resource for data and the at least one request for the CSI feedback are both transmitted, a scheduling priority for the data corresponding to the at least one second request is determined; and wherein the at least one request and the at least one second request are transmitted based on the scheduling priorities determined for the at least one CSI feedback and the data.

11. The method according to claim 9, wherein the scheduling priority for the CSI feedback is preconfigured as a fixed scheduling priority.

12. (canceled)

13. The method according to claim 1, wherein the shared channel is physical sidelink shared channel (PSSCH).

14. The method according to claim 1, wherein the request is one of:
a scheduling request (SR);
a medium access control (MAC) control element (CE); and
a radio resource control (RRC) signaling.

15. A method in a base station comprising:
receiving, from a terminal device, at least one request for allocating a resource for at least one channel state information (CSI) feedback; and
allocating a resource of a shared channel to the terminal device based on the at least one request.

16. The method according to claim 15, further comprising sending corresponding configuration of the CSI feedback to the terminal device, wherein each of the at least one request is received according to the corresponding configuration.

17. The method according to claim 16, wherein each of the at least one request is received with one of multiple predetermined resources; and wherein each of the multiple predetermined resources indicates a corresponding configuration of the CSI feedback.

18. The method according to claim 15, wherein one request is received for multiple CSI feedbacks.

19-22. (canceled)

23. The method according to claim 15, wherein the shared channel is physical sidelink shared channel (PSSCH).

24. The method according to claim 15, wherein the request is one of:
a scheduling request (SR);
a medium access control (MAC) control element (CE); and
a radio resource control (RRC) signaling.

25. A method in a terminal device comprising:
determining a scheduling priority for a channel state information (CSI) feedback;
determining a final scheduling priority for an incoming transmission based at least on the scheduling priority for the CSI feedback; and
allocating a resource of a shared channel for the incoming transmission based on the final scheduling priority.

26. (canceled)

27. The method according to claim 25, wherein the scheduling priority for the CSI feedback is preconfigured as a fixed scheduling priority.

28. The method according to claim 25, wherein the determining the final scheduling priority comprises:
determining whether the incoming transmission includes transmission of data;
when the incoming transmission includes transmission of data, determining the final scheduling priority as a higher value of the scheduling priority for the data and the scheduling priority for the CSI feedback; and
when the incoming transmission includes no transmission of data, determining the final scheduling priority as the scheduling priority for the lower layer signaling CSI feedback.

29. The method according to claim 25, wherein the scheduling priority is expressed by:
proximity based services (ProSe) per packet priority(PPPP); or
quality of service (QoS) information.

30. (canceled)

31. The method according to claim 25, wherein the shared channel is a physical sidelink shared channel (PSSCH).

32. A terminal device comprising:
at least one processor); and
at least one memory, the at least one memory containing instructions which, when executed by the at least one processor, cause the terminal device to:
transmit, to a base station, at least one request for allocating a resource for at least one channel state information (CSI) feedback; and
receive, from the base station, resource allocation of a shared channel in response to the at least one request.

33. (canceled)

34. A base station comprising:
at least one processor; and
at least one memory, the at least one memory containing instructions which, when executed by the at least one processor, cause the base station to:
receive, from a terminal device, at least one request for allocating a resource for at least one channel state information (CSI) feedback; and
allocate a resource of a shared channel to the terminal device based on the at least one request.

35. (canceled)

36. A terminal device comprising:
at least one processor; and
at least one memory, the at least one memory containing instructions which, when executed by the at least one processor, whereby cause the terminal device to:
determine a scheduling priority for a channel state information (CSI) feedback;
determine a final scheduling priority for an incoming transmission based at least on the scheduling priority for the CSI feedback; and
allocate a resource for the incoming transmission based on the final scheduling priority.

37-40. (canceled)
